(19) United States
(12) Patent Application Publication
(10) Pub. No.: US 2026/0342653 A1
(43) Pub. Date: Oct. 29, 2026

(54) PROACTIVE RESOURCE ALLOCATION AND POWER OPTIMIZATION IN INFORMATION TECHNOLOGY INFRASTRUCTURE USING TIME SERIES FORECASTING AND NEURAL NETWORK

(71) Applicant: Cisco Technology, Inc., San Jose, CA (US)

(72) Inventors: Arvind Vasudev Chari, New York, NY (US); Navin Ashok Suvarna, Holly Springs, NC (US); Dhrumil C. Prajapati, Apex, NC (US); Anupam Dey, Apex, NC (US); Sridhar Vaidyanathan, Maharashtra (IN)

(21) Appl. No.: 19/188,491

(22) Filed: Apr. 24, 2025

(51) Int. Cl. H04L 41/0833; H04L 41/142

(52) U.S. Cl. CPC H04L 41/0833; H04L 41/142

(57) ABSTRACT

Techniques for adjusting a power consumption of one or more network devices or one or more network device components. In one embodiment, a method includes obtaining multi-variate data inputs associated with one or more network devices operating in a network or one or more network device components. The method further includes processing, via a vector auto-regression model, the multi-variate data inputs to generate one or more forecast attributes associated with forecast outputs. The method further includes predicting, via a convolutional neural network, a stress level for each of the one or more network devices or the one or more network device components based on the one or more forecast attributes, and triggering, based on the stress level, one or more configuration actions to adjust a power consumption of the one or more network devices or the one or more network device components.

### TECHNICAL FIELD

The present disclosure relates to proactive resource allocation and power optimization in an information technology (IT) infrastructure. More specifically, the present disclosure relates to systems, apparatuses, and methods that utilize predictive analytics, real-time environmental and system telemetry, and centralized software-defined control to forecast resource usage and actively optimize energy consumption and cooling efficiency.

### BACKGROUND

In modern IT infrastructures, such as cloud data centers, Internet service providers (ISPs), enterprise networks and edge computing environments, the efficient allocation of network and system resources is critical for maintaining optimal performance, ensuring service level compliance and minimizing operational costs. These resources may include bandwidth, compute capacity, memory, storage, power and cooling systems, as well as routing paths and load distribution mechanisms. With advances in computing, the demand for computing, network, storage, and graphics processors is rising exponentially. These resources, hosted in various locations like campus facilities and data centers, should be optimally powered and cooled to ensure longevity and maintain performance. As technology evolves to meet the insatiable demand for productivity and innovation, the carbon footprint of the network resources, which is closely tied with power and cooling, will be a significant focus. Current network resource allocation methods and facility power and cooling management methods rely primarily on reactive approaches or simple static thresholds based on traffic conditions. These approaches have several limitations, such as reactive resource allocation, limited predictive capability, inability to handle multi-dimensional data, and inflexible resource allocation.

### BRIEF DESCRIPTION OF THE DRAWINGS

FIG. 1A is a block diagram illustrating a system for triggering configuration actions to adjust the power consumption of network devices or network device components, according to an example embodiment.

FIG. 1B is a diagram illustrating a grouping of network devices, according to an example embodiment.

FIG. 1C is a diagram illustrating a plurality of categories of data and corresponding metrics and types, according to an example embodiment.

FIG. 2 is a flow diagram illustrating a machine learning operations pipeline, according to an example embodiment.

FIG. 3 is a flow chart depicting a method for predicting stress levels of one or more network devices or one or more network device components, according to an example embodiment.

FIG. 4 is an operational sequence diagram illustrating a method for processing multi-variate input data via a Vector Auto-Regression (VAR) model, according to an example embodiment.

FIG. 5 is a diagram illustrating a multi-variate single-input convolutional neural network (CNN) for generating one or more predicted outputs based on output from a VAR model, according to an example embodiment.

FIG. 6 is a diagram illustrating a multi-variate multi-input convolutional neural network for generating one or more predicted outputs based on input data associated with a plurality of network devices, according to an example embodiment.

FIG. 7 is a diagram illustrating a multi-variate multi-input convolutional neural network for generating one or more predicted outputs based on input data associated with a plurality of network device components, according to an example embodiment.

FIG. 8 is a flow chart depicting a method for triggering one or more configuration actions to adjust a power consumption of the one or more network devices or the one or more network device components, according to an example embodiment.

FIG. 9 is a hardware block diagram of a computing device that may perform functions associated with operations discussed herein in connection with the techniques depicted.

### DETAILED DESCRIPTION

### Overview

Techniques are provided for adjusting a power consumption of one or more network devices or one or more network device components. In one embodiment, a method includes obtaining a plurality of multi-variate data inputs associated with one or more network devices operating in a network or one or more network device components. The method further includes processing, via a vector auto-regression model, the plurality of multi-variate data inputs to generate one or more forecast attributes associated with a plurality of forecast outputs for each of the one or more network devices or the one or more network device components. The method further includes predicting, via a convolutional neural network, a stress level for each of the one or more network devices or the one or more network device components based on the one or more forecast attributes, and triggering, based on the stress level, one or more configuration actions to adjust a power consumption of the one or more network devices or the one or more network device components.

### Example Embodiments

Power Use Effectiveness (PUE) quantifies how effectively a facility uses its power in relation to its IT equipment (e.g., network devices). For example, PUE may be measured using Equation (1) below:

Equation (1): Power Use Effectiveness Equation

$$P U E = \frac{Total Facility Energy}{IT Equipment Energy} = 1 + \frac{Non IT Facility Energy}{IT Equipment Energy}$$

The techniques provided herein leverage enhances PUE by integrating time series forecasting (e.g., Vector Auto-Regression (VAR) model) with predictions generated by one or more machine learning models (e.g., Convolutional Neural Networks (CNNs)). By predicting and managing the fluctuating demands of power and cooling systems in real time, the techniques provided herein proactively adjust resource use, optimize energy consumption, and significantly reduce environmental impact.

The forecasts, residuals, and rolling statistics generated by a VAR model serve as rich, structured inputs for CNNs. This pre-processing enriches the raw time-series data, transforming it into a format where CNNs can effectively detect spatial and hierarchical patterns across the data, such as temporal trends at different network levels or across various device metrics. By first using VAR to handle the linear aspects and CNNs to address the non-linear patterns, the combined approach is more robust against varied data dynamics compared to using either model alone. This dual approach mitigates the risk of model misspecification and improves the overall predictive performance. The use of VAR helps in efficiently reducing the dimensionality of the problem by focusing only on significant lags and relationships, thereby simplifying the input needed for the CNN. This can lead to more efficient training times and less complex network architectures while still maintaining high accuracy.

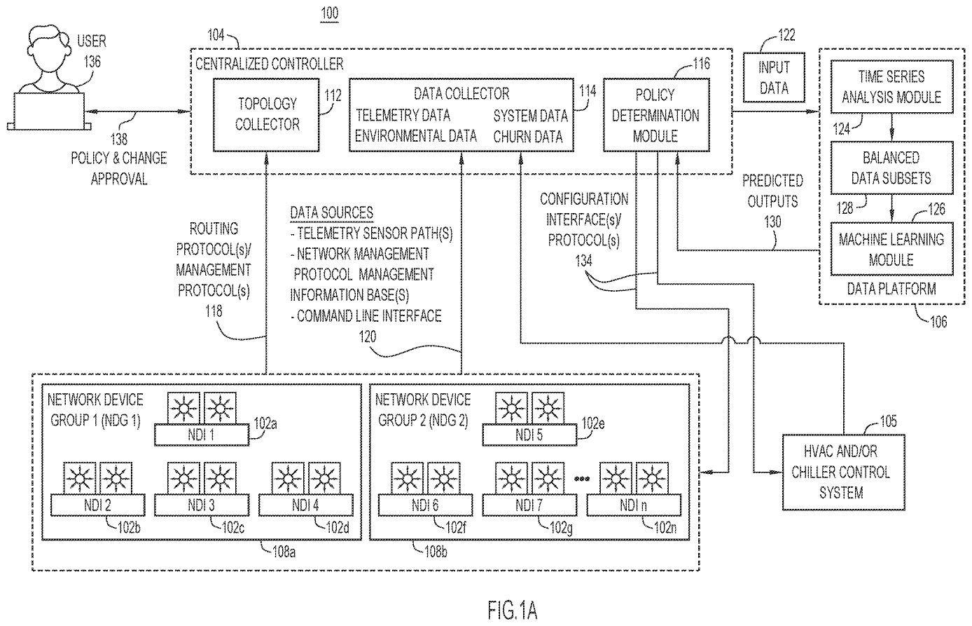

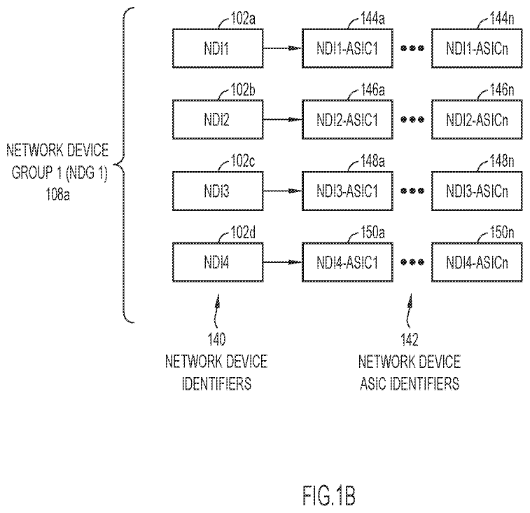

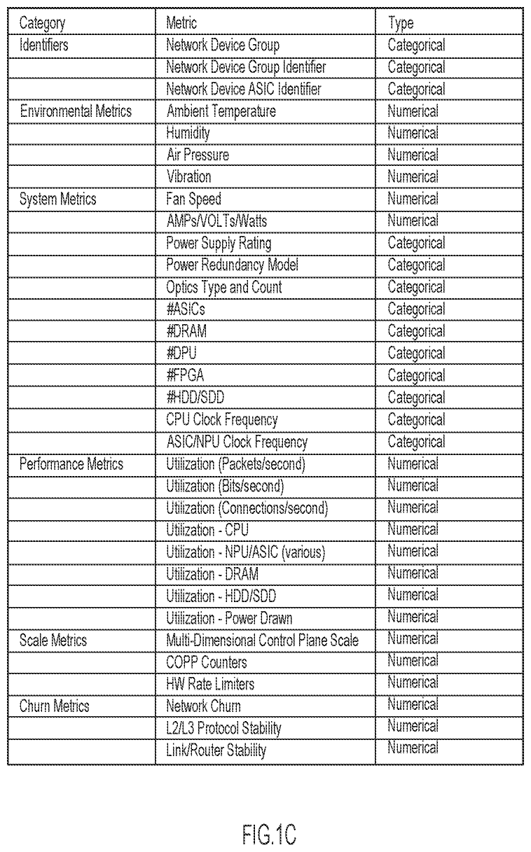

Reference is first made to FIG. 1A, for a description of a block diagram of a system 100 for triggering configuration actions to adjust the power consumption of network devices or network device components, according to an example embodiment. The system 100 includes a plurality of network devices 102a, 102b, 102c, 102d, 102e, 102f, 102g . . . 102n (also collectively denoted 102a-n), a centralized controller 104, a heating, ventilation, and air conditioning (HVAC) and/or chiller control system 105, and a data platform 106. The notation “a-n” denotes that a number is not limited, can vary widely, and depends on a particular use case scenario.

The network devices 102a-n operate in a network and can be a mobile phone, a computer (e.g., desktop or laptop), a server, a router, a switch, a modem, a gateway, a firewall, a load balancer, or any other suitable device. Each of the network devices 102a-n may be identified using a unique identifier that reflects the origin of the network device within the network topology. By way of example, the network device 102a may be associated with the identifier “NDI 1,” the network device 102b may be associated with the identifier “NDI 2,” the network device 102c may be associated with the identifier “NDI 3,” the network device 102d may be associated with the identifier “NDI 4,” the network device 102e may be associated with the identifier “NDI 5,” the network device 102f may be may be associated with the identifier “NDI 6,” the network device 102g may be associated with the identifier “NDI 7,” and the network device 102n may be identified with “NDI n.” The unique identifier can include any suitable identifier that distinguishes one network device from another. In certain embodiments, the unique identifier may be randomly generated and/or assigned.

In certain embodiments, the network devices 102a-n may be placed into a plurality of groups based on one or more device characteristics, such as device location, device type, components in a device, performance capability of the device, or any other suitable device characteristic. In certain embodiments, the network devices 102a-n may be grouped randomly or based on their unique identifiers. In one example, a first group of network devices identified by a first grouping 108a (e.g., “Network Device Group 1”) may include network devices with the identifiers “NDI 1,” “NDI 2,” “NDI 3,” and “NDI 4,” and a second group of network devices identified by a second grouping 108b (e.g., “Network Device Group 2”) may include network devices “NDI 5,” “NDI 6,” “NDI 7,” and “NDI n.” Each of the network devices 102a-n may include one or more network device components, such as a disk, a Central Processing Unit (CPU), an Application Specific Integrated Circuit (A SIC), a Flexible Programmable Grid Array (FPGA), a Distributed Processing Unit (DPU), a Dynamic Random Access Memory (DRAM), a Solid State Drive (SSD), or any other suitable network device component.

The network devices 102a-n may communicate with the centralized controller 104 via one or more suitable protocols and/or interfaces. The centralized controller 104 includes a topology collector 112, a data collector 114, and a policy determination module 116. In certain embodiments, the centralized controller 104 may be a software defined network (SDN) controller configured to manage and/or control a SDN to enable dynamic network configuration. The topology collector 112 may be configured to communicate with and/or collect network topology data from the network devices 102a-n via one or more routing protocols or management protocols 118. For example, the one or more routing protocols or management protocols 118 may include Border Gateway Protocol-Link State (BGP-LS), Simple Network Management Protocol (SN MP), SDN-provided application programming interface (API), Network Configuration Protocol (NETCONF), or any other suitable protocols. Network topology data collected by the topology collector 112 may include bandwidth, link status, inter-device connectivity data, relationships between devices and their redundancy levels, or any other suitable information describing the network topology. For example, the topology collector 112 may identify critical devices (e.g., core routers) that play a central role in the network versus edge devices with redundant backups.

In certain embodiments, the topology data is integrated with the policy determination module 116 to enable context-aware decision-making. For example, the redundancy level of a network device determines the extent to which its power consumption can be optimized. If a network device has no redundancy, the policy determination module 116 may prioritize performance over power savings. Moreover, integrating Configuration Management Database (CM DB) enhances device identification, while IT Service Management (ITSM) provides insights into devices scheduled for maintenance. Access to Change Request Management (CRM) systems provides information on the approval status of maintenance or change activities, thus ensuring that all policy decisions are well-informed.

The data collector 114 is configured to collect telemetry data, environmental data, system data, and/or churn data from one or more data sources 120 associated with the network devices 102a-n. For example, the data sources 120 may include one or more telemetry sensor paths associated with one or more sensors, one or more management information bases (MIBs) associated with simple network management protocols (e.g., SNMPMIBs), one or more command line interfaces, or any other suitable data source. In certain embodiments, the one or more data sources 120 may include Configuration Management Databases (CMDBs), Information Technology Service Management (ITSM), Change Advisory Board Approval (CAB) records, Performance Management (PM) Key Performance Indicators (KPIs), Fault Management (FM) data, or any other suitable source.

The telemetry data can include bandwidth usage monitored across different network paths and/or tagged with specific identifiers associated with a segment and/or device, server load metrics (e.g., Central Processing Unit (CPU) usage, Graphics Processing Units (GPU) usage, memory usage, power draw, fan speed, network traffic statistics, or disk operations labeled according to their network segment), and traffic flow data and/or error rates (e.g., packet data and error metrics collected in real-time with metadata describing their network path and node). The telemetry data may further include one or more metrics describing resource utilization, device temperature, power consumption, network traffic volume, frequency of one or more network device components, data on error rates, response times, system uptime, reliability and/or efficiency metrics, or any other suitable metric.

Environmental data may include HVAC and/or chiller system data such as ambient temperature (e.g., average ambient temperature) at an inlet fan used to cool a network device/network device component, vibration sensor data, humidity sensor data, motion sensor data, in-device sensor data, or data from associated chiller systems, such as coolant flow rates, condenser pressure or compressor energy consumption. Environmental data may further include data obtained from real-time external sources (e.g., weather forecast reports, geological activity reports, etc.) or any other suitable environmental data. In certain embodiments, the data collector 114 is configured to collect the environmental data from the HVAC and/or chiller control system 105. Moreover, data collector 114 is configured to collect system data such as diagnostic data, system logs, etc., and churn data such as device usage pattern, user feedback data, etc.

The data collector 114 may be configured to collect data from one or more data sources 120 based on one or more data collection strategies. For example, the one or more data collection strategies may include continuously collecting data from strategic vantage points within the network to create a comprehensive and timely dataset, labeling the data with unique identifiers that reflect their origin within the network topology to ensure accurate segment-specific analysis and forecasting, collecting/storing the data in real-time or near-real-time over a substantial period (e.g., several months to a year), or any other suitable data collection strategies. The one or more data collection strategies allow for the curation of a robust data set that can be used to train a model effectively on different patterns and anomalies. In certain embodiments, the data collector 114 may collect identifiers information (network device identifiers or network device component identifiers), system metrics, scale metrics, or vendor-specific metrics, etc. The data collected can provide a comprehensive view of the operational states of a network device, which is critical for accurately predicting the stress level. For example, a spike in CPU utilization combined with rising temperature may indicate an impending thermal or power stress scenario that may warrant proactive action. The categories of data collected may depend on user-defined requirements and/or data availability to fully capture the dynamics and specifics of a network environment.

The centralized controller 104 may be configured to provide the data (e.g., real-time and/or historical data) collected by the topology collector 112 and/or the data collector 114 as input data 122 to the data platform 106. The input data 122 may include single-variate input data or multi-variate input data (e.g., multi-variate time series data) associated with the network devices 102a-n and/or one or more network device components in the network devices 102a-n. For example, a multi-variate dataset capturing both transient (short-term spikes) and sustained (seasonal trends) behaviors for the device may be captured. Then, the input data 122 is parsed, structured, and/or standardized into a machine-readable format. In certain embodiments, the input data 122 may be processed by one or more data processing applications (e.g., Kafka® and Flink®) to generate one or more data pipelines. KAFKA and Flink are registered trademarks of the A pache Software Foundation.

The data platform 106 includes a time series analysis module 124 and a machine learning module 126. The time series analysis module 124 is configured to perform time series analysis on the input data 122 to generate a plurality of balanced data subsets 128 that are representative of the input data 122. For example, the plurality of balanced data subsets 128 may include a plurality of forecast outputs and/or one or more forecast attributes associated with the plurality of forecast outputs. In certain embodiments, the time series analysis may be performed via any suitable time series forecasting/analysis model, such as a Vector Auto-Regression (VAR) model. The plurality of balanced data subsets 128 may be provided to the machine learning module 126 to generate one or more predicted outputs 130 (e.g., predicted stress level).

Based on the plurality of balanced data subsets 128, the machine learning module 126 may be configured to implement one or more machine learning models to predict the stress level of a network device or a network device component (e.g., network devices 102a-n and/or their respective network device components). The one or more machine learning models may include a neural network (e.g., feed-forward neural network, convolutional neural network, recurrent neural network, etc.), a support vector machine, a transformer-based model (e.g., large language model), a hybrid model including multiple machine learning models, or any other suitable machine learning model.

The one or more predicted outputs 130 are provided to the policy determination module 116 to determine one or more policies for deploying one or more configuration actions. In certain embodiments, the one or more policies may be determined by combining one or more predicted outputs 130, topology data (e.g., device criticality and redundancy levels), and/or business logic (e.g., custom rules defined for each use case). For example, the one or more policies include deploying one or more configuration actions based on the stress level (e.g., predicted stress level) of a network device or a network device component. For example, stress levels may be categorized into high stress, medium stress, or low stress based on comparison to a dynamic threshold. The dynamic threshold may be determined or adjusted based on user-defined requirements/preferences or network conditions. In certain embodiments, low stress indicates a network device or a network device component is operating under optimal conditions with minimal resource usage; medium stress indicates moderate usage that is within the acceptable performance and power consumption parameters but may need monitoring for potential escalation; and high stress signals that the network device or network device component is experiencing near-capacity levels of resource usage, which may compromise performance and efficiency if not addressed promptly.

In one example, the one or more policies may include immediately deploying configuration actions to adjust the power consumption of the network device or network device component if high stress level is detected while scheduling configuration actions to be deployed at a later time if low or medium stress level is detected. In another example, if a critical device is predicted to experience high stress, the policy determination module 116 may provide a policy to increase the device's clock frequency to maintain performance. For low-stress devices with high redundancy, the policy may include reducing the clock frequency to save power. By predicting stress levels in advance using time series analysis (e.g., VAR model) and machine learning model (e.g., CNN model), gradual adjustments can be made to resources, thus avoiding sudden or frequent shifts that lead to thrashing. In certain embodiments, the one or more policies for deploying one or more configuration actions may take into consideration predefined Service Level Agreements (SLAs) to ensure that performance standards are maintained without compromising operational objectives.

In certain embodiments, the predicted stress levels may be used to determine the predicted load of the network devices 102a-n. Moreover, the predicted stress levels may be used to determine and provide a “per-device (or system)” and/or “per-component level” recommendation of configuration actions to tune the device/component via the device (or controller system managing the device, such as the centralized controller 104) to reduce power consumption at a per-device or per-component level. One or more recommended configuration actions may be provided based on the predicted stress level and deployed based on the one or more policies.

For example, the recommended configuration actions derived may be tuned to consider very short term (e.g., days/weeks), short term (months), medium term (quarters) and long term (years) worth of data to ensure seasonality and trends are monitored in the context of optimizing power. For example, in the context of a data center network topology, the data platform 106 may account for a new type of virtual machine instance that has launched recently and is extremely popular by tuning stress levels less aggressively based on very short-term datasets. Another example is, when determining whether to tune the stress level on popular shopping days, the model predicts a sustained load higher than a typical weekday leading to a prediction that the stress level should be higher based on long term data. In another example, when the model considers a link that has failed on a primary Data Center Interconnect Router and excludes the secondary router from any optimization based on fault management data received from the SDN controller. In yet another example, a scheduled upgrade on a particular layer of infrastructure devices may allow the model to predict that the load on adjacent devices on the same layer of the network will be increased, thus leading to no stress level adjustment on the layer of the network for the specified hierarchy of the topology. In certain embodiments, specific thresholds for stress level changes (e.g., changing from low stress to high stress) must be met before any system adjustments are made via the one or more configuration actions. Moreover, one or more dampening mechanisms that prevent oscillation and frequent toggling between states may be implemented. For example, a threshold may be applied such that a device transitions to a high-stress state only if the CPU temperature exceeds 85 °C, and returns to medium-stress state only when the temperature falls below 75 °C. A minimum hold time may also be enforced, wherein once a configuration change (such as increasing cooling capacity or reducing power draw) is applied, the system must wait for a defined duration, e.g., 30 minutes, before another adjustment is permitted. Rate-limiting mechanisms may be used to cap the number of allowed transitions per hour, helping to maintain system stability. In some cases, configuration actions may only be triggered if the stress level is sustained with sufficient confidence for a continuous time-interval/duration. These mechanisms collectively ensure system responsiveness while avoiding overreaction to short-lived or statistically insignificant changes in environmental or system conditions.

Upon determining the one or more policies for deploying one or more configuration actions, the policy determination module 116 may be configured to provide the one or more policies to a user 136 in a policy and change approval process 138. For example, during the policy and change approval process 138, the user 136 (e.g., a system administrator) may evaluate the one or more policies and approve/disapprove one or more configuration actions that may adjust the power consumption of a network device or network device component. The user 136 may provide an indication of approval/disapproval or a request to change the configuration action to the policy determination module 116. In certain embodiments, the user 136 and the centralized controller 104 may communicate (e.g., the user 136 providing the approval/disapproval or change request) via webhook, email, application programming interface (API), or any suitable interface. Upon receiving approval and/or the request to change the configuration action, the policy determination module 116 may communicate and/or deploy one or more configuration actions to the network devices 102a-n and/or the HVAC and/or chiller control system 105 via one or more configuration interfaces/protocols 134. For example, the one or more configuration interfaces/protocols 134 may include Representational State Transfer (REST) protocols (e.g., Hypertext Transfer Protocol Secure (HTTPS)), command line interface (CLI) interface, Network Configuration Protocol (NETCONF), Open Platforms Communications-Unified Architecture (OPC-UA), a southbound protocol, or any other suitable interface or protocol.

In certain embodiments, the one or more configuration actions may be triggered/deployed to adjust the power consumption of the one or more network devices or the one or more network device components. For example, the one or more configuration actions may include an adjustment to clock frequency, an adjustment to fan speed, an adjustment to a data transfer protocol, or any suitable configuration actions. In certain embodiments, the one or more configuration actions may include one or more heating, ventilation, and air conditioning (HVAC) and/or chiller control system configuration actions that modify the operations of the HVAC and/or chiller control system 105. For example, the one or more HVAC and/or chiller control system configuration actions may include adjusting the ambient temperature, adjusting the humidity of the environment housing a network device, adjusting the cooling setpoints, fan speeds, and/or airflow management of the one or more network devices or the one or more network device components, or any other suitable HVAC and/or chiller control system configuration action.

After deploying one or more configuration actions, the centralized controller 104 and/or the HVAC and/or chiller control system 105 may be configured to return a binary decision for each network device and/or network device component regarding whether a particular configuration action has been successfully applied. Then, in certain embodiments, the system 100 may be configured to measure the new PU E to document any increased efficiency of sustainability metrics. The machine learning module 126 may be continuously trained based on real-time streaming telemetry data to ensure that a particular configuration action has not had any negative impact on key performance indicators (KPIs) until the machine learning module 126 predicts that the stress-levels are changing again, at which point a continuous self-optimized feedback loop for determining and triggering configuration actions may be repeated. In certain embodiments, if the K PIs trend negatively after a configuration action is deployed to reach a predicted stress level, the machine learning module 126 may be configured to instruct the controller (e.g., centralized controller 104 or HVAC and/or chiller control system 105) to revert the stress level for the specific network device or network device component back to original state while continuing to maintain other devices/systems operating in the network to ensure Service Level Agreements (SLAs) are not impacted any further. Moreover, K PIs such as packet drop indicators or real-time unforecasted increases in utilization may be monitored after the one or more configuration actions are deployed.

Reference is now made to FIG. 1B, for a description of a diagram further illustrating the first grouping 108a of network devices, according to an example embodiment. The first grouping 108a (e.g., “Network Device Group 1”) may include network devices 102a, 102b, 102c, and 102d, respectively identified by “NDI 1,” “NDI 2,” “NDI 3,” and “NDI 4” of network device identifiers 140. Each of network devices 102a, 102b, 102c, and 102d may include one or more network device components uniquely identified by a network device component identifier (e.g., network device ASIC identifiers 142). For example, each of network devices 102a, 102b, 102c, and 102d includes one or more ASICs each identified by a network device ASIC identifier. By way of example, the network device 102a includes a plurality of ASICs 144a . . . 144n (also collectively denoted 144a-n) respectively identified by “NDI1-ASIC1” . . . “NDI1-ASICn”; network device 102b includes a plurality of ASICs 146a . . . 146n (also collectively denoted 146a-n) identified by “NDI2-ASIC1” . . . “NDI2-ASICn”; network device 102c includes a plurality of ASICS 148a . . . 148n (also collectively denoted 148a-n) identified by “NDI3-ASIC1” . . . “NDI3-ASICn”; and network device 102d includes a plurality of ASICs 150a . . . 150n (also collectively denoted 150a-n) identified by “NDI4-ASIC1” . . . “NDI4-ASICn.”

Reference is now made to FIG. 1C, for a description of a diagram illustrating a plurality of categories of data and their corresponding metrics and types, according to an example embodiment. The categories of data that may be collected include identifiers, environmental metrics, system metrics, performance metrics, scale metrics, and churn metrics. The data collected may be used to generate one or more predictions (e.g., predicted stress level) as described in various embodiments herein.

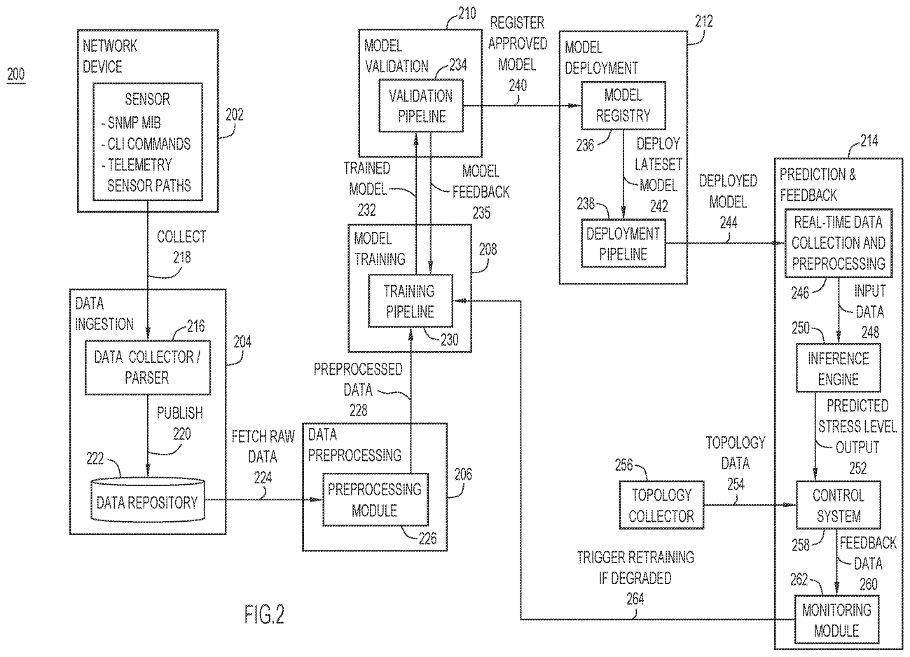

Reference is now made to FIG. 2, for a description of a block diagram illustrating a machine learning operations pipeline 200 for predicting stress levels of one or more network devices (e.g., a network device 202) or network device components, according to an example embodiment. The machine learning operations pipeline 200 includes a plurality of operations, such as a data ingestion operation 204, a data preprocessing operation 206, a model training operation 208, a model validation operation 210, a model deployment operation 212, and a prediction and feedback operation 214. The machine learning operations pipeline 200 may be configured to implement the end-to-end development, deployment, and monitoring of one or more machine learning models used for predicting stress level for network devices.

In the data ingestion operation 204, a data collector/parser 216 may be configured to collect and/or parse data from the network device 202. For example, at 218, the data collector/parser 216 may be configured to collect data (e.g., telemetry data, environmental data, system data, churn data, etc.) from one or more data sources associated with the network device 202. The data may include single-variate input data or multi-variate input data (e.g., multi-variate time series data). The data sources may include one or more telemetry sensor paths associated with one or more sensors, one or more management information bases (MIBs) associated with simple network management protocols (e.g., SNMP MIBs), one or more command line interfaces, or any other suitable data source. In certain embodiments, the one or more data sources may include Configuration Management Databases (CMDBs), Information Technology Service Management (ITSM), Change Advisory Board Approval (CAB) records, Performance Management (PM) Key Performance Indicators (KPIs), and/or Fault Management (FM) data. In certain embodiments, the data collector/parser 216 may parse the collected data using suitable data parsing techniques. Then, at 220, the data collector/parser 216 may be configured to publish the collected and/or parsed data to a data repository 222 (e.g., a central data repository).

At 224, the data preprocessing operation 206 may be configured to fetch raw data from the data repository 222. Then, the data preprocessing operation 206 may be configured to preprocess the raw data via a preprocessing module 226. The preprocessing module 226 may be configured to preprocess the raw data via one or more data standardization techniques and time series analysis. In one example, the preprocessing module 226 may be configured to preprocess the raw data (e.g., multi-variate time series data) through a series of operations, including imputing missing values to ensure data consistency, and aligning timestamps to synchronize metrics across devices. The preprocessing module 226 may also perform standardization of numerical data (e.g., converting temperature readings to a consistent unit), and encode categorial features (e.g., power supply mode: gold/platinum) into numerical representations for downstream processing via a forecasting model, such as a VAR model for lagged variables or features. Then, the data preprocessing operation 206 provides the preprocessed data 228 to the model training operation 208. In certain embodiments, the preprocessed data may include forecast outputs and/or one or more forecast attributes associated with the forecast outputs.

The model training operation 208 may be configured to train a machine learning model (e.g., a CNN) via a training pipeline 230 that includes training of the CNN and tuning hyperparameters. That is, for example, the CNN may be trained based on the preprocessed data 228 to generate one or more predicted outputs (e.g., predicted stress levels), which may be used to determine one or more configuration actions that may be deployed to adjust the power consumption of a network device or network device components. The machine learning model (e.g., CNN) may be trained iteratively to optimize its parameters (e.g., weights) and refine its outputs until a stopping criterion is met. For example, the stopping criterion may include a prediction accuracy threshold (e.g., accuracy at 85% or higher), execution time, a number of iterations, or any suitable stopping criterion. The stopping criterion may be determined based on user requirement/preference and/or resource limitations. Moreover, one or more hyperparameters (e.g., learning rate, batch size, number of CNN layers, etc.) of the machine learning model may be tuned iteratively to optimize a set of hyperparameters that enables the machine learning model to achieve optimized performance (e.g., highest prediction accuracy). For example, the number of convolutional filters is adjusted to match the complexity of telemetry data from diverse device groups.

After the machine learning model is trained, the model training operation 208 may be configured to provide a trained model 232 to the model validation operation 210. The model validation operation 210 may evaluate and validate the trained model 232 via a validation pipeline 234. The validation pipeline 234 may be configured to evaluate the trained model 232 and generate one or more performance metrics (e.g., prediction accuracy, precision, recall, and F1-score, etc.). The one or more performance metrics may be tracked during training to ensure the model meets predefined benchmarks. In certain embodiments, the machine learning operations pipeline 200 may include a mechanism to stop training early if performance metrics plateau, thus preventing overfitting.

The validation pipeline 234 may be configured to validate the trained model 232 using a holdout dataset or cross-validation techniques. For example, validation metrics such as inference latency, prediction accuracy, and robustness to varying telemetry conditions are evaluated. Based on the validation metrics, the validation pipeline 234 may be configured to approve or disapprove the trained model 232 and provide model feedback 235 to the training pipeline 230. Then, an approved model is provided to the model deployment operation 212, which includes a model registry 236 and a deployment pipeline 238. At 240, the approved model is registered in the model registry 236. At 242, the model registry 236 may be configured to deploy the latest model to the deployment pipeline 238. Then, the deployment pipeline 238 may be configured to deploy a model (e.g., latest model) from the model registry 236 to a centralized controller. That is, for example, the deployment pipeline 238 may be configured to provide a deployed model 244 to the prediction and feedback operation 214 to be used for inference/prediction.

The prediction and feedback operation 214 may integrate the deployed model into the operational workflow, thus connecting the machine learning operations pipeline 200 to a control system (e.g., centralized network controller) for real-time decisions. The prediction and feedback operation 214 may perform real-time data collection and preprocessing 246 by collecting real-time data inputs and performing data ingestion and data processing on the data inputs. The resulting processed input data 248 may be provided to an inference engine 250 configured to predict the stress level of a network device or a network device component to generate predicted stress level output 252. The predicted stress level output 252, topology data 254 (e.g., network topology data) provided by a topology collector 256, and one or more policies/rules are provided to a control system 258 (e.g., software-defined network (SDN), HVAC and/or chiller control system, power control system, etc.) to determine and trigger one or more configuration actions (e.g., adjustment to clock frequency) to adjust the power consumption of one or more network devices (e.g., network device 202) or network device components in substantially the same manner as described above.

The control system 258 may be configured to provide feedback data 260 to a monitoring module 262. For example, the feedback data 260 may include model performance of the deployed model 244 determined based on a difference between the predicted stress level output 252 and the actual stress level (e.g., ground truth) of a particular network device or network device component. The monitoring module 262 may be configured to continuously monitor the model performance (e.g., prediction accuracy, effect on device based on configuration action, etc.) and trigger retraining if model performance has degraded. For example, at 264, the monitoring module 262 may communicate with the training pipeline 230 to retrain the deployed model 244 based on an evaluation that model performance (e.g., prediction accuracy) has degraded to a predetermined threshold. The operations of the machine learning operations pipeline 200 may proceed in an iterative and continuous manner until a predetermined condition is met. The predetermined condition may be determined based on user requirement and/or preference. Thus, the model is continuously updated with fresh telemetry data to ensure its adaptability to evolving network conditions. The hybrid VAR and CNN model offers comparatively improved interpretability, lower computational overhead and better robustness to volatile telemetry data signals, making it more suitable for real-time infrastructure optimization tasks.

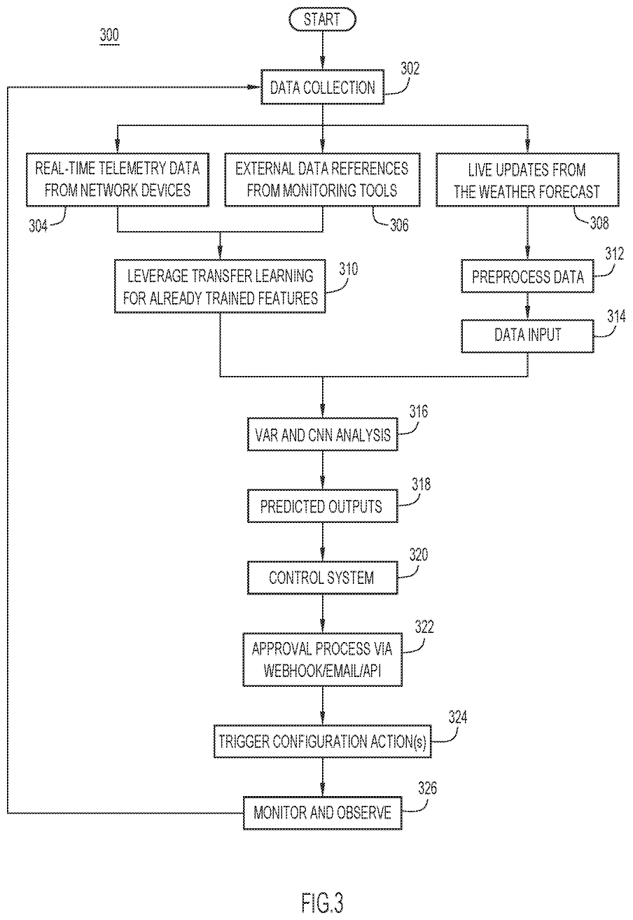

Reference is first made to FIG. 3, for a description of a method 300 for predicting stress levels of one or more network devices or one or more network device components via VAR and CNN analysis, according to an example embodiment. The method 300 begins at 302, where a data collection operation is performed to collect input data from one or more sources. In certain embodiments, data collection may be performed in accordance with one or more data collection strategies as described above. Based on the data collection operation, real-time telemetry data from one or more network devices is obtained at 304, external data references from one or more monitoring tools are obtained at 306, and live updates from the weather forecast are obtained at 308. At 310, real-time telemetry data and external data references may be processed by leveraging transfer learning for already trained features. At 312, live updates from the weather forecast are preprocessed using suitable preprocessing techniques to generate data input at 314.

At 316, VAR and CNN analysis is performed on input data including the processed data from 310 and the data input generated at 314. In certain embodiments, the input data may include single-variate input data or multi-variate input data (e.g., multi-variate time series data) associated with one or more network devices and/or one or more network device components. The input data are provided to a VAR model to generate a plurality of forecast outputs and/or one or more forecast attributes associated with the plurality of forecast outputs. The plurality of forecast outputs generated by the VAR model may include forecasts for each of the input data (e.g., input metrics such as bandwidth usage, server loads, traffic flow, etc.) based on historical and real-time data. These forecasts may include predicted values for short and medium terms, which are critical for proactive planning. Moreover, one or more attributes associated with the plurality of forecast outputs may be generated. For example, the one or more attributes may include one or more residuals, one or more rolling statistics, correlation data, or any other suitable forecast attribute.

The one or more residuals include differences between actual observed values and the values predicted by the VAR model. These residuals may be indicative of the non-linearities or anomalies in the data. The one or more rolling statistics may include moving averages, variances, or any other rolling measure that smooths out short-term fluctuations and highlights longer-term trends in the data. This information helps to stabilize the model inputs and provides a more consistent baseline from which the CNN can detect deviations. The correlation data may include insights into how various network metrics influence each other over time. For example, the correlation data may include lagged relationships that help identify cause-effect scenarios across different segments of the network.

The plurality of forecast outputs and/or one or more forecast attributes may be provided to a CNN to generate one or more predicted outputs, such as predicted stress level. In certain embodiments, the one or more predicted outputs include a predicted ambient temperature (e.g., ambient temperature of environment where a network device is located). In one example, cooling of a facility/environment may be working even when there is a lack of activity in the network during certain time periods (e.g., nighttime when all devices are already running in optimal low performance mode). Moreover, additional cooling might not be required if the weather outside the facility is cooler. For example, for the data centers located in colder climates, when the temperature in the winter is below 0 degrees Celsius, the facility chillers can be tuned down as external climate will have an influence on the ambient temperature of the data center. In these examples, the predicted ambient temperature may be used to reach an equilibrium where network devices' thresholds are not exceeded while increase in temperature would reduce power consumption for the chillers.

At 318, the VAR and CNN analysis may provide one or more predicted outputs. At 320, the one or more predicted outputs may be provided to a control system (e.g., soft-defined network controller, a HVAC and/or chiller control system, a power control system, etc.). Then, an approval process may be initiated at 322. That is, for example, a user (e.g., a system administrator) may evaluate the one or more predicted outputs to approve/disapprove one or more configuration actions that may adjust the power consumption of a network device or network device component. The user may provide an indication of approval/disapproval or a request to change the configuration action to the control system. In certain embodiments, the user and the control system may communicate (e.g., the user providing the approval/disapproval or change request) via webhook, email, application programming interface (API), or any suitable interface. Upon receiving user approval or change request, one or more configuration actions may be triggered at 324. Then, at 326, the one or more network devices and/or one or more network device components are monitored and observed to collect additional data at 302. The operations of the method 300 may proceed iteratively until a user-defined condition is met (e.g., prediction accuracy reaching a threshold).

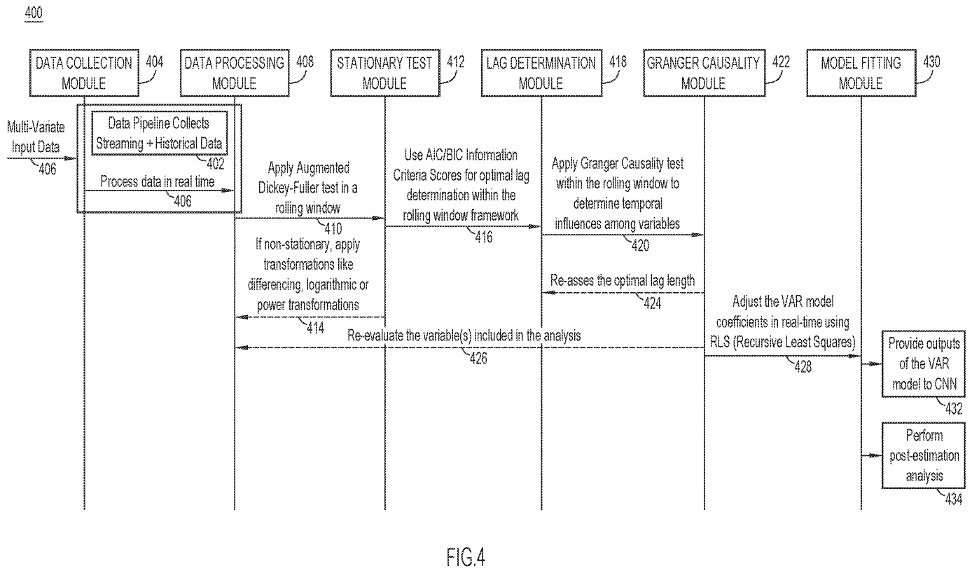

Reference is first made to FIG. 4, for a description of an operational sequence diagram illustrating a method 400 for processing multi-variate input data via a VAR model, according to an example embodiment. The method 400 begins at 402, where a data collection module 404 may be configured to implement a data pipeline to collect streaming and historical data (e.g., multi-variate input data 406). In certain embodiments, streaming telemetry data (real-time operational metrics) may also be included in the multi-variate input data 406. At 408, the multi-variate input data 406 is provided to a data processing module 408 configured to process the data in real time. In certain embodiments, the multi-variate input data 406 may include network device group, network device identifier, network device component (e.g., A SIC) identifier, ambient temperature, fan speed, AMPs/VOLTs, power supply rating, power redundancy model, optics, humidity, air pressure, vibration, reload, number of ASICs, number of DRAM, number of Hard Disk Drives (HDD)/Solid State Drives (SDD), utilization metrics (e.g., measured using packets/second, bits/second, connections/second, etc.), Multi-D Control Panel Scale, frequency based power draw, Control Plane Policing (COPP) counters, hardware rate limiters, network churn ([0/1]), L2/L3 protocol stability ([0/1]), link/router stability ([0/1]), or any other suitable input data. In certain embodiments, the multi-variate input data 406 is parsed and structured into a unified format suitable for time series analysis via one or more operations, including aligning timestamps to ensure synchronization of metrics across devices, standardizing numerical data for consistency (e.g., converting temperature to a standard unit), encoding categorical features (e.g., power supply mode: gold/platinum) for numerical processing, etc.

At 410, a stationary test module 412 may be configured to apply Augmented Dickey-Fuller (ADF) test in a rolling window to the processed multi-variate input data to determine whether the data is stationary or non-stationary (i.e., whether statistical properties like mean and variance remain constant over time). If the processed multi-variate input data is determined to be non-stationary, one or more transformations, such as differencing (e.g., removes trends by subtracting the previous value from the current value), logarithms transformation (e.g., stabilizes variance for metrics with exponential growth, such as CPU utilization during traffic surges), or power transformations (e.g., reduces skewness for metrics like fan speed or vibration data), may be applied at 414. In certain embodiments, non-stationary environmental data, such as inlet temperature trends during summer months, can introduce noise into predictions. Transforming non-stationary environmental data ensures the model focuses on relevant patterns rather than spurious trends. Then, at 416, a lag determination module 418 may be configured to use A kaike Information Criterion (AIC) or Bayesian Information Criterion (BIC) information criteria scores for optimal lag determination within the rolling window framework (e.g., to determine the optimal number of lagged observations for the VAR model). This process identifies the lag length that best captures temporal dependencies between metrics while minimizing model complexity. For example, CPU utilization might be influenced by its values from the past 3-time steps, while link stability might depend on the longer-term trends (e.g., 7-time steps). Optimal lag selection ensures the model captures these dependencies without overfitting or underfitting.

At 420, a Granger Causality module 422 may be configured to apply a Granger Causality test within the rolling window to determine temporal influences among variables and causal relationships between variables. In certain embodiments, based on determined temporal influences, the lag determination module 418 may be configured to re-assess the optimal lag length at 424 and adjust lag selection to account for newly identified dependencies. The data processing module 408 may be configured to re-evaluate the variable(s) included in the analysis at 426 (e.g., remove irrelevant variables or include additional metrics that exhibit significant causal influence). For example, identifying that fan speed changes are causally influenced by both temperature and vibration data ensures the VAR model incorporates these relationships, thus improving feature relevance and predictive accuracy.

Then, at 428, a model fitting module 430 may be configured to adjust the VAR model coefficients in real-time using recursive least squares (RLS). By dynamically updating VAR coefficients using RLS, the method 400 adapts to evolving real-time conditions, such as seasonal temperature fluctuations or sudden traffic surges, to ensure predictions remain accurate. At 432, one or more outputs of the VAR model may be provided to a CNN. That is, for example, the one or more outputs (e.g., forecasts, residuals, and rolling statistics, etc.) of the VAR model may be transformed into a structured multi-dimensional matrix (e.g., N-dimensional array format) that is organized into distinct channels for each metric. This structured data serves as feature-engineered input for the CNN. The CNN leverages these engineered features to detect complex temporal and spatial patterns, such as correlations between sustained temperature increases and gradual power draw spikes. At 434, post-estimation analysis of the one or more outputs of the VAR model may be performed. For example, the post-estimation analysis may be performed using Impulse Response Function (e.g., quantify the impact of a shock to one variable (e.g., a sudden temperature spike) on other variables over time) and Forecast Error Variance Decomposition (e.g., decompose the variance in a forecasted metric (e.g., CPU utilization) into contributions from various input metrics (e.g., link stability, A SIC power draw, etc.). Results from the post-estimation analysis are provided as feedback to a controller (e.g., network controller).

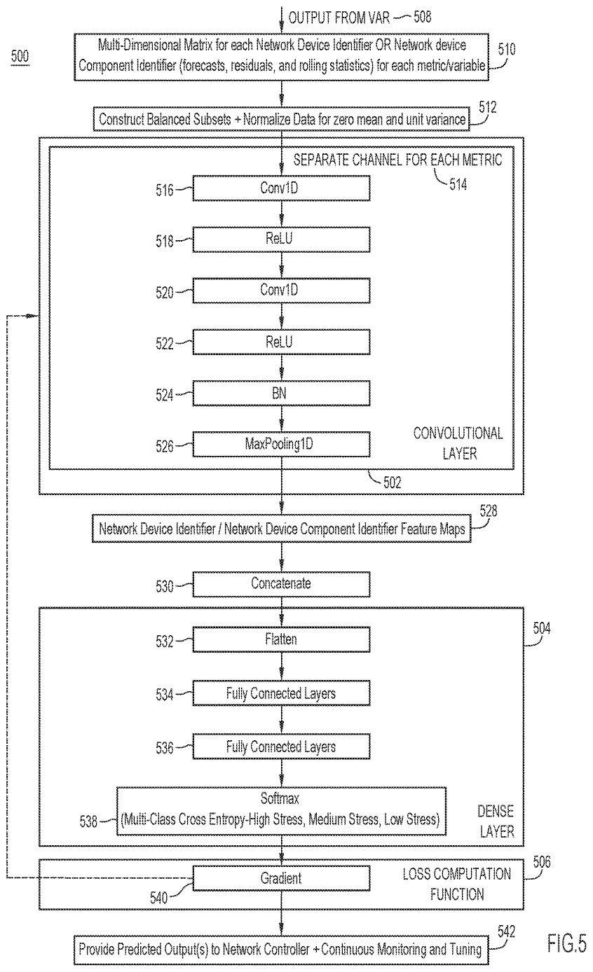

Reference is made to FIG. 5, for a description of a diagram illustrating a multi-variate single-input convolutional neural network 500 for generating one or more predicted outputs based on output from a VAR model, according to an example embodiment. The multi-variate single-input convolutional neural network 500 includes a convolutional layer 502, a dense layer 504, and a loss computation function 506. For example, the multi-variate single-input convolutional neural network 500 may be a single-input CNN. Output (e.g., forecasts, residuals, and rolling statistics, etc.) from a VAR model (e.g., the VAR model of FIG. 4) 508 may be transformed into a multi-dimensional matrix for each network device identifier or network device component identifier for each metric/variable at 510. The multi-variate single-input convolutional neural network 500 processes data separately for each network device identifier or network device component identifier to ensure that device-specific patterns and unique operational characteristics are preserved. That is, for example, the multi-dimensional matrix divides the data into distinct channels for each network metric and segment, similar to color channels in images, thus effectively mapping the network's spatial and temporal data. Examples of network metrics may include bandwidth, signal strength, error rates, or any other suitable metric. The multi-variate single-input convolutional neural network 500 can interpret the residuals and forecasts produced by the VAR model, uncovering deeper insights that are not apparent through linear analysis alone. At 512, the multi-dimensional matrix may be processed to construct balanced subsets and normalized for zero mean and unit variance. To facilitate effective learning and improve the model's ability to generalize, the data for each feature is normalized to have zero mean and unit variance. This normalization process standardizes the scale of the input features, making them more comparable and speeding up the convergence of the neural network. Moreover, the data is segmented into balanced subsets to ensure that the process is not biased toward any particular trend or pattern.

The matrix channels (e.g., separate channel for each metric 514) are provided as input to the convolutional layer 502, which is configured to convert the matrix channels into feature maps for CNN processing. Each channel, representing a different network metric or segment, is treated as a unique feature in the data “image.” The convolutional layer 502 may extract spatial and temporal patterns, such as repeated spikes in utilization metrics or correlations between environmental and system factors. The convolutional layer 502 may be configured to perform a sequence of operations on the matrix channels, including a 1D convolution (Conv1D) operation 516, a rectified linear activation function (ReLU) 518, a Conv1D operation 520 followed by ReL U 522, batch normalization (BN) 524, and a 1D max pooling (MaxPooling1D) operation 526, to generate network device identifier/network device component identifier feature maps 528. The CNN may be configured to use these feature maps to identify complex, non-linear interactions across network segments, thereby improving network performance predictions and resource management.

In the multi-dimensional matrix, each metric-such as bits per second, packets per second, and connections per second-represents a separate channel. Each channel is composed of forecasts and forecast attributes (e.g., residuals, rolling statistics, etc.) for its respective metric. The Conv1D operations (e.g., Conv1D operation 516 and Conv1D operation 520) apply filters across these data points to extract temporal features specific to each metric, capturing trends and anomalies within the time series data. This selective feature extraction allows for independent analysis of temporal patterns from multiple network metrics, which are then synthesized in later stages through fully connected layers to uncover complex interdependencies and spatial relationships among the metrics.

ReLU 522 introduces non-linearity to the model, allowing it to learn more complex patterns by outputting the input directly if it is positive; otherwise, it outputs zero. Batch normalization 524 normalizes the activations of the previous layer at each batch by applying a transformation that maintains the mean output close to 0 and the output standard deviation close to 1. This stabilizes the learning process and reduces the number of training epochs required to train deep networks. The MaxPooling1D operation 526 reduces the dimensionality of each feature map but retains the most important information. M ax pooling simplifies the outputs by taking the maximum value of each window in the feature map.

The network device identifier/network device component identifier feature maps 528 are concatenated at 530 to generate concatenated feature maps. In certain embodiments, the convolutional layers in the multi-variate single-input convolutional neural network 500 utilize multiple filters across the individual channels corresponding to each metric, such as bits per second or packets per second. Each channel processes its own temporal features independently at first. After the convolutional and pooling layers, these feature maps are integrated through a concatenation step. This step merges the independent feature maps into a comprehensive feature representation that combines multiple network metrics' temporal dynamics. This concatenated feature set is then fed into the fully connected layers, where the combined information from all channels is synthesized to identify complex interdependencies and spatial relationships among the metrics.

That is, for example, the concatenated feature maps are provided to the dense layer 504, which may be configured to flatten the concatenated feature maps at 532 (e.g., flattened into a one-dimensional array), and process the flattened feature maps through a plurality of fully connected layers at 534. Then, the resulting feature maps are again processed through another plurality of fully connected layers at 536. These fully-connected layers further synthesize the features extracted by the convolutional layers/operations by forming higher-level attributes representing complex interdependencies across inputs. This process is crucial for recognizing patterns that are not obvious when metrics are analyzed in isolation, thus leveraging the network's full potential for accurate stress level prediction across network devices or network device components (e.g., ASICs).

Then, the resulting feature maps are processed by a softmax function at 538 to generate a predicted output (e.g., the label “high stress,” “medium stress,” or “low stress”) based on predicted probabilities associated with each class. Based on the predicted output, multi-class cross-entropy may be determined and provided to the loss computation function 506, which is configured to calculate a gradient 540. The gradient 540 may be provided to the convolutional layer 502 in an iterative manner to train the multi-variate single-input convolutional neural network 500 via gradient descent by iteratively adjusting model parameters (e.g., weights and biases) to minimize the multi-class cross-entropy. Upon determining that the training of the multi-variate single-input convolutional neural network 500 is complete (e.g., multi-class cross-entropy is minimized to a user-defined acceptable level), predicted output(s) may be provided to a network controller (e.g., SDN controller) at 542 to trigger a configuration action as described above. This allows for dynamic adjustments and continuous monitoring of network and environmental conditions, thus facilitating proactive interventions to optimize power consumption. Moreover, at 542, continuous monitoring and tuning of the predicted output(s) may be performed.

Thus, after processing the input data, the multi-variate single-input convolutional neural network 500 may provide refined outputs that are more predictive and insightful for dynamic network management. For example, the multi-variate single-input convolutional neural network 500 may adjust or refine the forecasts provided by VAR by identifying patterns that might have been missed by the VAR model. This could include detecting sudden changes in traffic that are not typical based on historical trends. Moreover, the multi-variate single-input convolutional neural network 500 may perform anomaly detection by identifying unusual patterns or potential issues that could affect network performance, which may be non-linear and complex patterns that VAR cannot easily predict. Further, the multi-variate single-input convolutional neural network 500 may provide specific recommendations for resource allocation based on the analyzed data, which may include suggested configurations for maximizing efficiency and performance.

In certain embodiments, the outputs from the multi-variate single-input convolutional neural network 500 are used to enhance network management and operations through proactive measures. For example, real-time modifications to Quality-of-Service (QoS) settings may be implemented based on the refined forecasts and anomaly detections provided by the multi-variate single-input convolutional neural network 500, thus ensuring that network quality is maintained under varying traffic conditions. Moreover, utilizing the predictive insights, traffic may be rerouted and balanced proactively across the network to prevent congestion before it starts affecting performance based on both current and anticipated network conditions. Further, based on the comprehensive analysis, compute and network resources may be dynamically scaled up or down. This auto-scaling may be guided by the advanced forecasts, thus ensuring resources are utilized efficiently according to the predicted demand and thereby reducing operational costs and enhancing user experience. The integration of outputs from both VAR and CNN models provides enhanced network resource allocation, turning reactive network management into a proactive and data-driven framework. This not only minimizes the risk of network congestion and performance degradation, but also optimizes the allocation of resources to meet both current and future demands effectively.

In one example, the multi-variate single-input convolutional neural network 500 may be leveraged to generate predictions that may be used for telecommunications network traffic management. For example, the telecommunications network may collect hourly data on bandwidth usage, packet loss, and signal strength from multiple branches, such as urban centers, rural areas, and suburban zones. Data inputs may include time-stamped measurements of bandwidth usage, packet loss rates, and signal strength from various parts of the network. Each data point is tagged with geographic identifiers and device information to maintain context and relevance. A VAR model may be configured to analyze these data inputs to understand and forecast network behavior. The VAR model assesses the linear relationships between different metrics across time and space, providing a foundation for predicting future network conditions. Outputs from the VAR model may include forecasts (e.g., predicted future values for each metric, such as anticipated bandwidth usage and expected packet loss rates in different network segments), residuals highlighting deviations from the predicted norms, which can indicate anomalies or emerging issues not captured by historical trends, rolling statistics (e.g., rolling means and variances for each metric, smoothing out short-term fluctuations to highlight more significant trends), correlation data (e.g., analysis of how changes in metrics in one area of the network affects conditions in other parts.), etc. Correlatin data may include lagged relationships which help identify potential cause-and-effect scenarios that are crucial for proactive network management.

The outputs from the VAR model (e.g., forecasts, residuals, rolling statistics, etc.) are organized into a multi-dimensional matrix. The matrix organizes the data into distinct channels, including channel 1 for bandwidth usage forecast, channel 2 for packet loss residuals, and channel 3 for signal strength rolling statistics. Each channel represents a different aspect of the network's operational metrics, formatted to mirror the network's geographic segmentation. This structured approach ensures that each segment of data is treated as a separate feature within the CNN, akin to channels in color image processing. Then, the VAR-derived structured multi-dimensional matrix, akin to a multi-channel image, is prepared for CNN input. Each pixel or cell in this “image” represents a geographic segment at a specific time, encapsulating various network metrics. Thus, the VAR-CNN combined analysis captures both temporal patterns (how traffic changes over time) and spatial patterns (how traffic behaves across different parts of the network) while providing real-time, adaptive resource management that minimizes congestion and optimizes network performance.

In a feature map creation operation, the CNN may be configured to processes the “image” (the structured matrix) using its convolutional layers to detect patterns that are not apparent through linear analysis alone. For example, it might discover that sudden spikes in bandwidth usage in urban centers often precede signal degradation in nearby suburban zones. Then, in a filter application, filters designed within the CNN may target specific patterns to capture complex interactions, such as the spread of high traffic load from urban to rural areas. The CNN outputs refined predictions about where and when the network might face traffic bottlenecks or signal strength issues, based on both linear forecasts and non-linear spatial interactions detected.

Outputs from CNNs (e.g., predicted stress level) may inform real-time adjustments to resource allocation. For example, if an upcoming spike in bandwidth demand is predicted in an urban center, additional bandwidth can be preemptively routed there to handle the surge and prevent service degradation. By identifying patterns that indicate potential issues, maintenance can be scheduled proactively to address faults before they impact network performance, such as rerouting traffic away from a potentially failing server. Moreover, using detailed insights provided by the CNN, network traffic can be efficiently managed by adjusting routes proactively, balancing loads to avoid congested nodes, and enhancing overall network reliability. Monitoring capabilities may be enhanced by allowing network operators to apply adjustments in real-time based on the CNN's predictions, thus ensuring optimal performance and minimizing operational disruptions. Further, long-term planning benefits from accurate predictions of network load and resource requirements, which may be used to guide decisions on infrastructure investment and upgrades.

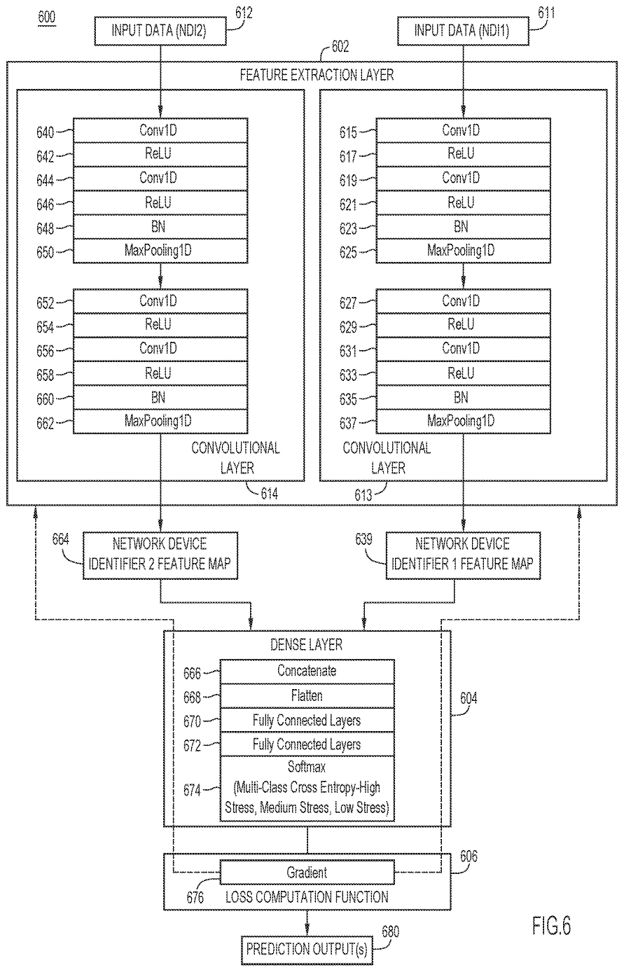

Reference is made to FIG. 6, for a description of a diagram illustrating a multi-variate multi-input convolutional neural network 600 for generating one or more predicted outputs based on input data associated with a plurality of network devices, according to an example embodiment. The multi-variate multi-input convolutional neural network 600 includes a feature extraction process 602, a dense layer 604, and a loss computation function 606. The feature extraction process 602 may be provided input data from a plurality of network devices, such as input data 611 associated with a first network device identified by the identifier “NDI1” and input data 612 associated with a second network device identified by the identifier “NDI2.” Each network device's VAR output forms a unique input stream to a CNN branch, thus enabling tailored feature extraction for a group of devices, effectively highlighting distinct performance patterns and stress levels across a network device group. This approach also ensures that specific characteristics and anomalies of grouped devices are accurately captured, thus facilitating more nuanced and actionable insights into their operational health. In certain embodiments, the input data 611 and/or input data 612 may include outputs (e.g., forecasts, residuals, and rolling statistics, etc.) from a VAR model as described above. The input data 611 and input data 612 are each tagged with a unique network device identifier to maintain context and relevance and reflect the origin of the network device within the network topology.

The input data 611 and input data 612 are provided to the feature extraction process 602. In certain embodiments, each of the input data 611 and input data 612 may be transformed into a multi-dimensional matrix. That is, for example, the multi-dimensional matrix divides the data into distinct channels for each network metric and segment. Examples of network metrics may include bandwidth, signal strength, error rates, or any other suitable metric. Then, the multi-dimensional matrix representing input data 611 is provided to a convolutional layer 613 and the multi-dimensional matrix representing input data 612 is provided to a convolutional layer 614 simultaneously in a parallel fashion.

The matrix channels of the multi-dimensional matrix representing the input data 611 are provided as input to the convolutional layer 613, which may be configured to convert the matrix channels into a feature map. The convolutional layer 613 may be configured to perform a sequence of operations on the matrix channels, including a 1D convolution (Conv1D) operation 615, a rectified linear activation function (ReLU) 617, a Conv1D operation 619 followed by ReLU 621, batch normalization (BN) 623, and a 1D max pooling (MaxPooling1D) operation 625. Then, the convolutional layer 613 may be configured to perform another sequence of operations, including a Conv1D operation 627, ReLU 629, a Conv1D operation 631 followed by ReLU 633, batch normalization 635 (BN), and a MaxPooling1D operation 637. Then, a feature map 639 associated with the network device identifier 1 (“NDI1”) is generated based on the operations in the convolutional layer 613.

The matrix channels of the multi-dimensional matrix representing the input data 612 are provided as input to the convolutional layer 614, which may be configured to convert the matrix channels into a feature map. The convolutional layer 614 may be configured to perform a sequence of operations on the matrix channels, including a 1D convolution (Conv1D) operation 640, a rectified linear activation function (ReLU) 642, a Conv1D operation 644 followed by ReLU 646, batch normalization (BN) 648, and a 1D max pooling (MaxPooling1D) operation 650. Then, the convolutional layer 614 may be configured to perform another sequence of operations, including a Conv1D operation 652, ReLU 654, a Conv1D operation 656 followed by ReLU 658, batch normalization (BN) 660, and a 1D max pooling (MaxPooling1D) operation 662. Then, a feature map 664 associated with the network device identifier 2 (“NDI2”) is generated based on the operations in the convolutional layer 614.

In the multi-dimensional matrix, each metric-such as bits per second, packets per second, and connections per second-represents a separate channel. Each channel is composed of forecasts, residuals, and rolling statistics for its respective metric. The Conv1D operations in the feature extraction process 602 apply filters across these data points to extract temporal features specific to each metric, capturing trends and anomalies within the time series data. This selective feature extraction allows for independent analysis of temporal patterns from multiple network metrics, which are then synthesized in later stages through fully connected layers to uncover complex interdependencies and spatial relationships among the metrics.

ReLU in the feature extraction process 602 introduces non-linearity to the model, allowing it to learn more complex patterns by outputting the input directly if it is positive; otherwise, it outputs zero. Batch normalization in the feature extraction process 602 normalizes the activations of the previous layer at each batch by applying a transformation that maintains the mean output close to 0 and the output standard deviation close to 1. This stabilizes the learning process and reduces the number of training epochs required to train deep networks. The MaxPooling1D operations in the feature extraction process 602 reduce the dimensionality of each feature map but retains the most important information. Max pooling simplifies the outputs by taking the maximum value of each window in the feature map.

The feature map 639 (associated with network device identifier 1) and the feature map 664 (associated with network device identifier 2) are provided to the dense layer 604. The dense layer 604 may be configured to concatenate the feature map 639 and the feature map 664 at 666 and then flatten the concatenated feature maps at 668. Concatenating the feature maps ensures a comprehensive feature set that combines insights across either multiple devices or multiple device components. At 670, the flattened feature maps are processed through a plurality of fully connected layers. Then, at 672, the resulting feature maps are again processed through another plurality of fully connected layers. The fully connected layers may be configured to synthesize inputs into predictions or classifications, such as identifying stress levels across a group of devices or across a group of device components within a device. This approach efficiently harnesses the CNN's capability to detect complex patterns, providing a robust tool for dynamic and real-time stress analysis. The resulting feature maps are processed by a softmax function at 674 to generate a predicted output (e.g., the label “high stress,” “medium stress,” or “low stress”) based on predicted probabilities associated with each class. Based on the predicted output, multi-class cross-entropy may be determined and provided to the loss computation function 606, which is configured to calculate a gradient 676. The gradient 676 may be provided to the convolutional layer 613 and the convolutional layer 614 in an iterative manner to train the multi-variate multi-input convolutional neural network 600 via gradient descent by iteratively adjusting model parameters (e.g., weights and biases) to minimize the multi-class cross-entropy. Upon determining that the training of the multi-variate multi-input convolutional neural network 600 is complete (e.g., multi-class cross-entropy is minimized to a user-defined acceptable level), predicted output(s) (e.g., predicted stress level for each of the plurality of network devices) may be provided at 680 to trigger one or more configuration actions as described above.

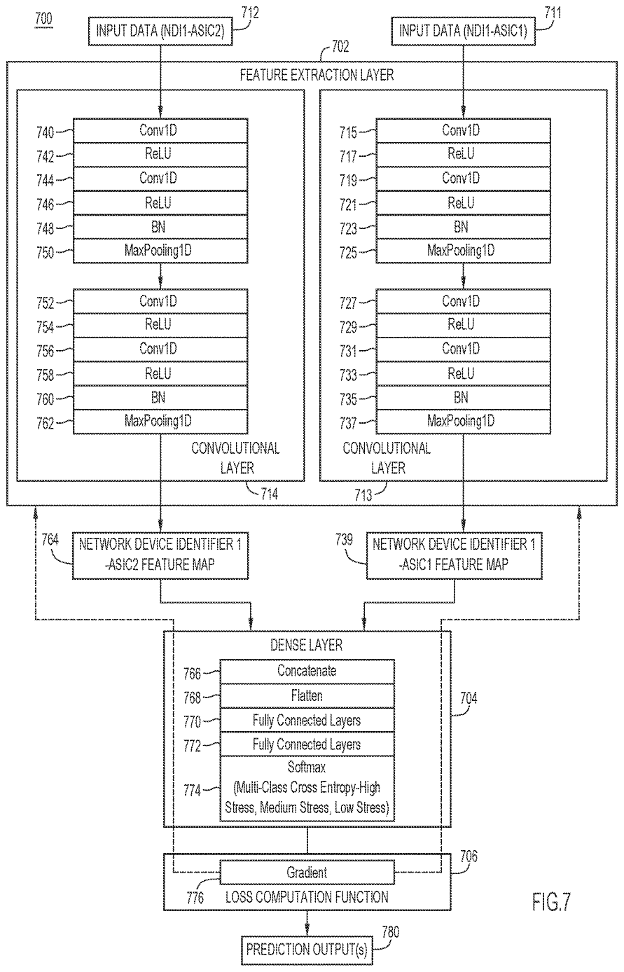

Reference is made to FIG. 7, for a description of a diagram illustrating a multi-variate multi-input convolutional neural network 700 for generating one or more predicted outputs based on input data associated with a plurality of network device components, according to an example embodiment. The multi-variate multi-input convolutional neural network 700 includes a feature extraction process 702, a dense layer 704, and a loss computation function 706. The feature extraction process 702 may be provided input data from a plurality of network device components, such as input data 711 associated with a first network device component (e.g., a first ASIC) identified by the identifier “NDI1-ASIC1” and input data 712 associated with a second network device component (e.g., a second ASIC) identified by the identifier “NDI1-ASIC2.” VAR outputs for individual network device component (e.g., A SICs) within each network device are treated as separate inputs. This enables evaluation of device component-level dynamics which can be critical for understanding granular device behavior under different network and environmental conditions. In certain embodiments, the first network device component and the second network device component may be associated with a same or different network device. In certain embodiments, the input data 711 and/or input data 712 may include outputs (e.g., forecasts, residuals, and rolling statistics, etc.) from a VAR model as described above. The input data 711 and input data 712 are each tagged with a unique network device component identifier to maintain context and relevance and reflect the origin of the network device component within the network topology.

The input data 711 and input data 712 are provided to the feature extraction process 702. In certain embodiments, each of the input data 711 and input data 712 may be transformed into a multi-dimensional matrix. That is, for example, the multi-dimensional matrix divides the data into distinct channels for each network metric and segment. Examples of network metrics may include bandwidth, signal strength, error rates, or any other suitable metrics. Then, the multi-dimensional matrix representing input data 711 is provided to a convolutional layer 713 and the multi-dimensional matrix representing input data 712 is provided to a convolutional layer 714 simultaneously in a parallel fashion.

The matrix channels of the multi-dimensional matrix representing the input data 711 are provided as input to the convolutional layer 713, which may be configured to convert the matrix channels into a feature map. The convolutional layer 713 may be configured to perform a sequence of operations on the matrix channels, including a 1D convolution (Conv1D) operation 715, a rectified linear activation function (ReLU) 717, a Conv1D operation 719 followed by ReLU 721, batch normalization (BN) 723, and a 1D max pooling (MaxPooling1D) operation 725. Then, the convolutional layer 713 may be configured to perform another sequence of operations, including a Conv1D operation 727, ReLU 729, a Conv1D operation 731 followed by ReLU 733, batch normalization 735, and a MaxPooling1D operation 737. Then, a feature map 739 associated with the network device component identified by “network device identifier 1-ASIC1” (“NDI1-ASIC1”) is generated based on the operations in the convolutional layer 713.

The matrix channels of the multi-dimensional matrix representing the input data 712 are provided as input to the convolutional layer 714, which may be configured to convert the matrix channels into a feature map. The convolutional layer 714 may be configured to perform a sequence of operations on the matrix channels, including a 1D convolutions (Conv1D) operation 740, a rectified linear activation function (ReLU) 742, a Conv1D operation 744 followed by ReLU 746, batch normalization (BN) 748, and a 1D max pooling (MaxPooling1D) operation 750. Then, the convolutional layer 614 may be configured to perform another sequence of operations, including a Conv1D operation 752, ReLU 754, a Conv1D operation 756 followed by ReLU 758, batch normalization (BN) 760, and a 1D max pooling (MaxPooling1D) operation 762. Then, a feature map 764 associated with the network device component identified by “network device identifier 1-A SIC2” (“NDI1-ASIC2”) is generated based on the operations in the convolutional layer 614.

The feature map 739 (associated with the network device component identified by “network device identifier 1-ASIC1”) and the feature map 764 (associated with the network device component identified by “network device identifier 1-ASIC2”) are provided to the dense layer 704. The dense layer 704 may be configured to concatenate the feature map 739 and the feature map 764 at 766 and then flatten the concatenated feature maps at 768. At 770, the flattened feature maps are processed through a plurality of fully connected layers. Then, at 772, the resulting feature maps are again processed through another plurality of fully connected layers. The resulting feature maps are processed by a softmax function at 774 to generate a predicted output (e.g., the label “high stress,” “medium stress,” or “low stress”) based on predicted probabilities associated with each class. Based on the predicted output, multi-class cross-entropy may be determined and provided to the loss computation function 706, which is configured to calculate a gradient 776. The gradient 776 may be provided to the convolutional layer 713 and the convolutional layer 714 in an iterative manner to train the multi-variate multi-input convolutional neural network 700 via gradient descent by iteratively adjusting model parameters (e.g., weights and biases) to minimize the multi-class cross-entropy. Upon determining that the training of the multi-variate multi-input convolutional neural network 700 is complete (e.g., multi-class cross-entropy is minimized to a user-defined acceptable level), predicted output(s) (e.g., predicted stress level for each of the plurality of network devices) may be provided at 780 to trigger one or more configuration actions as described above. The operations performed by various layers of the multi-variate multi-input convolutional neural network 700 can be implemented in substantially the same manner as those depicted by the neural network shown in FIG. 6.

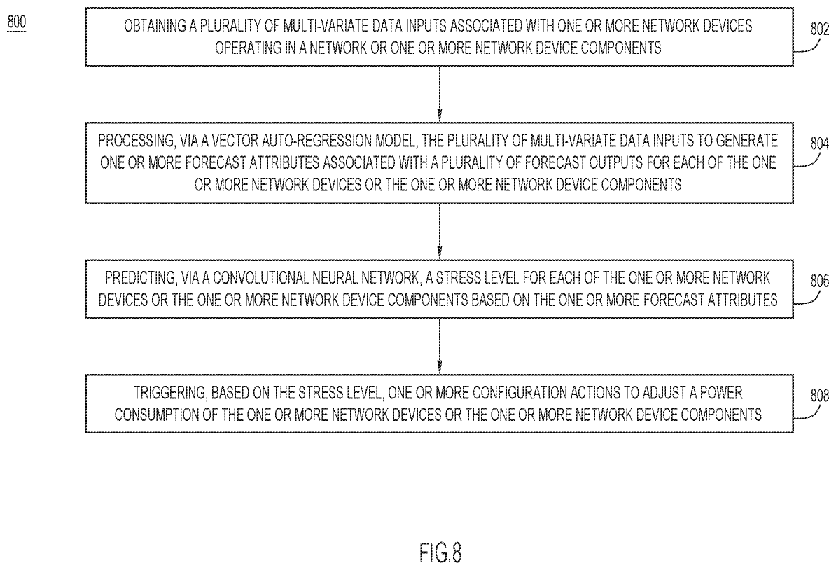

FIG. 8 is a flow diagram illustrating a method 800 for triggering one or more configuration actions to adjust a power consumption of the one or more network devices or the one or more network device components, according to an example embodiment.

At 802, the method 800 involves obtaining a plurality of multi-variate data inputs associated with one or more network devices operating in a network or one or more network device components.

At 804, the method 800 involves processing, via a vector auto-regression model, the plurality of multi-variate data inputs to generate one or more forecast attributes associated with a plurality of forecast outputs for each of the one or more network devices or the one or more network device components.

At 806, the method 800 involves predicting, via a convolutional neural network, a stress level for each of the one or more network devices or the one or more network device components based on the one or more forecast attributes.

At 808, the method 800 involves triggering, based on the stress level, one or more configuration actions to adjust a power consumption of the one or more network devices or the one or more network device components.

In the method 800, wherein the one or more forecast attributes include a plurality of residuals, a plurality of rolling statistics, or correlation data determined based on the plurality of forecast outputs, wherein the plurality of forecast outputs is generated by the vector auto-regression model.

In the method 800, wherein the plurality of residuals includes one or more differences between the plurality of forecast outputs and a plurality of actual time series values, and wherein the plurality of rolling statistics includes one or more of moving averages or one or more variances of the plurality of forecast outputs.

In the method 800, wherein the stress level is determined based on one or more metrics associated with the one or more network devices or the one or more network device components, and wherein the one or more metrics include resource utilization, temperature, power consumption, or network traffic volume.

In the method 800, wherein the triggering further involves adjusting the power consumption of the one or more network devices or the one or more network device components to reach a threshold power consumption associated with the stress level.

In the method 800, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

In the method 800, wherein the one or more configuration actions include one or more heating, ventilation, and air conditioning (HVAC) and/or chiller control system configuration actions that result in one or more adjustments to one or more cooling setpoints, one or more fan speeds, or an airflow management of the one or more network devices or the one or more network device components.

In the method 800, wherein the one or more network device components include a disk, a Central Processing Unit (CPU), an Application Specific Integrated Circuit (ASIC), a Flexible Programmable Grid Array (FPGA), a Distributed Processing Unit (DPU), a Dynamic Random Access Memory (DRAM), or a Solid State Drive (SSD).

In the method 800, wherein processing further involves transforming the plurality of forecast outputs and the one or more forecast attributes into one or more multi-dimensional matrices each associated with a network device or a network device component.

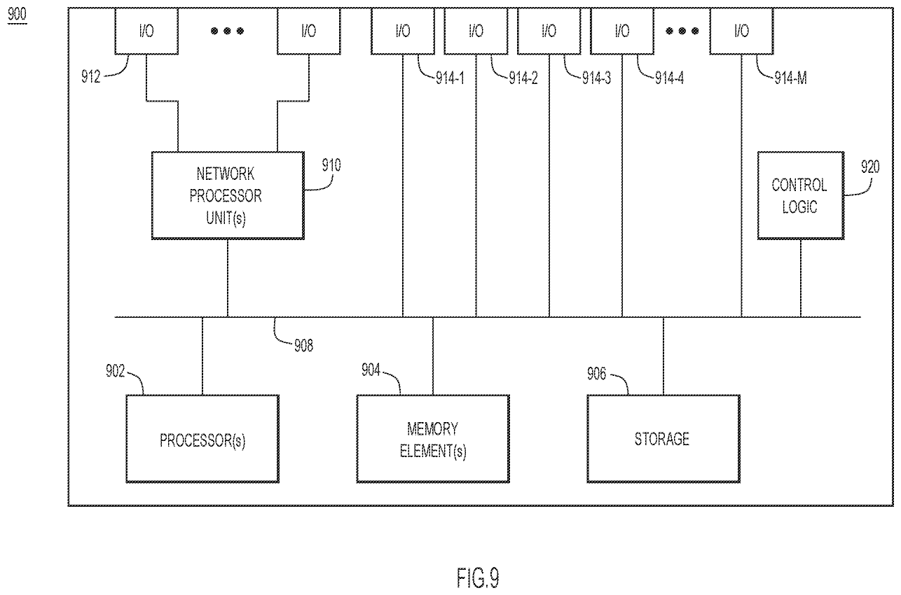

Referring to FIG. 9, FIG. 9 illustrates a hardware block diagram of a computing device 900 that may perform functions associated with operations discussed herein in connection with the techniques depicted in FIGS. 1A, 1B, 1C, and 2-8. In various embodiments, a computing device or apparatus, such as computing device 900 or any combination of computing devices 900, may be configured as any entity/entities as discussed for the techniques depicted in connection with FIGS. 1A, 1B, 1C, and 2-8 in order to perform operations of the various techniques discussed herein.

In at least one embodiment, the computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914-1, 914-2, 914-3, 914-4, . . . , 914-M, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914-1 to 914-M allow for input and output of data and/or information with other entities that may be connected to computing device 900. For example, I/O interface(s) 914-1 to 914-M may provide a connection to external devices. It is also envisioned that many of these external devices may be integrated as part of the computing device 900. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (A SIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: obtaining a plurality of multi-variate data inputs associated with one or more network devices operating in a network or one or more network device components; processing, via a vector auto-regression model, the plurality of multi-variate data inputs to generate one or more forecast attributes associated with a plurality of forecast outputs for each of the one or more network devices or the one or more network device components; predicting, via a convolutional neural network, a stress level for each of the one or more network devices or the one or more network device components based on the one or more forecast attributes; and triggering, based on the stress level, one or more configuration actions to adjust a power consumption of the one or more network devices or the one or more network device components.

In some aspects, the techniques described herein relate to a method, wherein the one or more forecast attributes include a plurality of residuals, a plurality of rolling statistics, or correlation data determined based on the plurality of forecast outputs, wherein the plurality of forecast outputs is generated by the vector auto-regression model.

In some aspects, the techniques described herein relate to a method, wherein the plurality of residuals includes one or more differences between the plurality of forecast outputs and a plurality of actual time series values, and wherein the plurality of rolling statistics includes one or more of moving averages or one or more variances of the plurality of forecast outputs.

In some aspects, the techniques described herein relate to a method, wherein the stress level is determined based on one or more metrics associated with the one or more network devices or the one or more network device components, and wherein the one or more metrics include resource utilization, temperature, power consumption, or network traffic volume.

In some aspects, the techniques described herein relate to a method, wherein triggering includes: adjusting the power consumption of the one or more network devices or the one or more network device components to reach a threshold power consumption associated with the stress level.

In some aspects, the techniques described herein relate to a method, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

In some aspects, the techniques described herein relate to a method, wherein the one or more configuration actions include one or more heating, ventilation, and air conditioning (HVAC) and/or chiller control system configuration actions that result in one or more adjustments to one or more cooling setpoints, one or more fan speeds, or an airflow management of the one or more network devices or the one or more network device components.

In some aspects, the techniques described herein relate to a method, wherein the one or more network device components include a disk, a Central Processing Unit (CPU), an Application Specific Integrated Circuit (ASIC), a Flexible Programmable Grid Array (FPGA), a Distributed Processing Unit (DPU), a Dynamic Random Access Memory (DRAM), or a Solid State Drive (SSD).

In some aspects, the techniques described herein relate to a method, wherein processing includes: transforming the plurality of forecast outputs and the one or more forecast attributes into one or more multi-dimensional matrices each associated with a network device or a network device component.

In some aspects, the techniques described herein relate to an apparatus including: a memory; and one or more processors coupled to the memory, wherein the one or more processors are configured to perform operations including: obtaining a plurality of multi-variate data inputs associated with one or more network devices operating in a network or one or more network device components; processing, via a vector auto-regression model, the plurality of multi-variate data inputs to generate one or more forecast attributes associated with a plurality of forecast outputs for each of the one or more network devices or the one or more network device components; predicting, via a convolutional neural network, a stress level for each of the one or more network devices or the one or more network device components based on the one or more forecast attributes; and triggering, based on the stress level, one or more configuration actions to adjust a power consumption of the one or more network devices or the one or more network device components.

In some aspects, the techniques described herein relate to an apparatus, wherein the one or more forecast attributes include a plurality of residuals, a plurality of rolling statistics, or correlation data determined based on the plurality of forecast outputs, wherein the plurality of forecast outputs is generated by the vector auto-regression model.

In some aspects, the techniques described herein relate to an apparatus, wherein the stress level is determined based on one or more metrics associated with the one or more network devices or the one or more network device components, and wherein the one or more metrics include resource utilization, temperature, power consumption, or network traffic volume.

In some aspects, the techniques described herein relate to an apparatus, wherein triggering includes: adjusting the power consumption of the one or more network devices or the one or more network device components to reach a threshold power consumption associated with the stress level.

In some aspects, the techniques described herein relate to an apparatus, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

In some aspects, the techniques described herein relate to an apparatus, wherein the one or more configuration actions include one or more heating, ventilation, and air conditioning (HVAC) and/or chiller control system configuration actions that result in one or more adjustments to one or more cooling setpoints, one or more fan speeds, or an airflow management of the one or more network devices or the one or more network device components.

In some aspects, the techniques described herein relate to an apparatus, wherein the one or more network device components include a disk, a Central Processing Unit (CPU), an Application Specific Integrated Circuit (ASIC), a Flexible Programmable Grid Array (FPGA), a Distributed Processing Unit (DPU), a Dynamic Random Access Memory (DRAM), or a Solid State Drive (SSD).

In some aspects, the techniques described herein relate to one or more non-transitory computer readable storage media encoded with instructions that, when executed by a processor, cause the processor to: obtain a plurality of multi-variate data inputs associated with one or more network devices operating in a network or one or more network device components; process, via a vector auto-regression model, the plurality of multi-variate data inputs to generate one or more forecast attributes associated with a plurality of forecast outputs for each of the one or more network devices or the one or more network device components; predict, via a convolutional neural network, a stress level for each of the one or more network devices or the one or more network device components based on the one or more forecast attributes; and trigger, based on the stress level, one or more configuration actions to adjust a power consumption of the one or more network devices or the one or more network device components.

In some aspects, the techniques described herein relate to one or more non-transitory computer readable storage media, wherein the instructions are operable to cause the processor to trigger, based on the stress level, one or more configuration actions to adjust a power consumption of the one or more network devices or the one or more network device components by: adjusting the power consumption of the one or more network devices or the one or more network device components to reach a threshold power consumption associated with the stress level.

In some aspects, the techniques described herein relate to one or more non-transitory computer readable storage media, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

In some aspects, the techniques described herein relate to one or more non-transitory computer readable storage media, wherein the one or more configuration actions include one or more heating, ventilation, and air conditioning (HVA C) and/or chiller control system configuration actions that result in one or more adjustments to one or more cooling setpoints, one or more fan speeds, or an airflow management of the one or more network devices or the one or more network device components.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Public and Hybrid Cloud network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining a plurality of multi-variate data inputs associated with one or more network devices operating in a network or one or more network device components;
processing, via a vector auto-regression model, the plurality of multi-variate data inputs to generate one or more forecast attributes associated with a plurality of forecast outputs for each of the one or more network devices or the one or more network device components;
predicting, via a convolutional neural network, a stress level for each of the one or more network devices or the one or more network device components based on the one or more forecast attributes; and
triggering, based on the stress level, one or more configuration actions to adjust a power consumption of the one or more network devices or the one or more network device components.

2. The method of claim 1, wherein the one or more forecast attributes include a plurality of residuals, a plurality of rolling statistics, or correlation data determined based on the plurality of forecast outputs, wherein the plurality of forecast outputs is generated by the vector auto-regression model.

3. The method of claim 2, wherein the plurality of residuals includes one or more differences between the plurality of forecast outputs and a plurality of actual time series values, and wherein the plurality of rolling statistics includes one or more of moving averages or one or more variances of the plurality of forecast outputs.

4. The method of claim 1, wherein the stress level is determined based on one or more metrics associated with the one or more network devices or the one or more network device components, and wherein the one or more metrics include resource utilization, temperature, power consumption, or network traffic volume.

5. The method of claim 1, wherein triggering comprises:
adjusting the power consumption of the one or more network devices or the one or more network device components to reach a threshold power consumption associated with the stress level.

6. The method of claim 1, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

7. The method of claim 1, wherein the one or more configuration actions include one or more heating, ventilation, and air conditioning (HVAC) and/or chiller control system configuration actions that result in one or more adjustments to one or more cooling setpoints, one or more fan speeds, or an airflow management of the one or more network devices or the one or more network device components.

8. The method of claim 1, wherein the one or more network device components include a disk, a Central Processing Unit (CPU), an Application Specific Integrated Circuit (ASIC), a Flexible Programmable Grid Array (FPGA), a Distributed Processing Unit (DPU), a Dynamic Random Access Memory (DRAM), or a Solid State Drive (SSD).

9. The method of claim 1, wherein processing comprises:
transforming the plurality of forecast outputs and the one or more forecast attributes into one or more multi-dimensional matrices each associated with a network device or a network device component.

10. An apparatus comprising:
a memory; and
one or more processors coupled to the memory, wherein the one or more processors are configured to perform operations including:
obtaining a plurality of multi-variate data inputs associated with one or more network devices operating in a network or one or more network device components;
processing, via a vector auto-regression model, the plurality of multi-variate data inputs to generate one or more forecast attributes associated with a plurality of forecast outputs for each of the one or more network devices or the one or more network device components;
predicting, via a convolutional neural network, a stress level for each of the one or more network devices or the one or more network device components based on the one or more forecast attributes; and
triggering, based on the stress level, one or more configuration actions to adjust a power consumption of the one or more network devices or the one or more network device components.

11. The apparatus of claim 10, wherein the one or more forecast attributes include a plurality of residuals, a plurality of rolling statistics, or correlation data determined based on the plurality of forecast outputs, wherein the plurality of forecast outputs is generated by the vector auto-regression model.

12. The apparatus of claim 10, wherein the stress level is determined based on one or more metrics associated with the one or more network devices or the one or more network device components, and wherein the one or more metrics include resource utilization, temperature, power consumption, or network traffic volume.

13. The apparatus of claim 10, wherein triggering comprises:
adjusting the power consumption of the one or more network devices or the one or more network device components to reach a threshold power consumption associated with the stress level.

14. The apparatus of claim 10, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

15. The apparatus of claim 10, wherein the one or more configuration actions include one or more heating, ventilation, and air conditioning (HVAC) and/or chiller control system configuration actions that result in one or more adjustments to one or more cooling setpoints, one or more fan speeds, or an airflow management of the one or more network devices or the one or more network device components.

16. The apparatus of claim 10, wherein the one or more network device components include a disk, a Central Processing Unit (CPU), an Application Specific Integrated Circuit (ASIC), a Flexible Programmable Grid Array (FPGA), a Distributed Processing Unit (DPU), a Dynamic Random Access Memory (DRAM), or a Solid State Drive (SSD).

17. One or more non-transitory computer readable storage media encoded with instructions that, when executed by a processor, cause the processor to:
obtain a plurality of multi-variate data inputs associated with one or more network devices operating in a network or one or more network device components;
process, via a vector auto-regression model, the plurality of multi-variate data inputs to generate one or more forecast attributes associated with a plurality of forecast outputs for each of the one or more network devices or the one or more network device components;
predict, via a convolutional neural network, a stress level for each of the one or more network devices or the one or more network device components based on the one or more forecast attributes; and
trigger, based on the stress level, one or more configuration actions to adjust a power consumption of the one or more network devices or the one or more network device components.

18. The one or more non-transitory computer readable storage media of claim 17, wherein the instructions are operable to cause the processor to trigger, based on the stress level, one or more configuration actions to adjust a power consumption of the one or more network devices or the one or more network device components by:
adjusting the power consumption of the one or more network devices or the one or more network device components to reach a threshold power consumption associated with the stress level.

19. The one or more non-transitory computer readable storage media of claim 17, wherein the one or more configuration actions include an adjustment to clock frequency, an adjustment to fan speed, or an adjustment to a data transfer protocol, and wherein the one or more configuration actions are implemented automatically via a Software Defined Network (SDN) Controller.

20. The one or more non-transitory computer readable storage media of claim 17, wherein the one or more configuration actions include one or more heating, ventilation, and air conditioning (HVAC) and/or chiller control system configuration actions that result in one or more adjustments to one or more cooling setpoints, one or more fan speeds, or an airflow management of the one or more network devices or the one or more network device components.
